(19) United States
(12) Patent Application Publication
(10) Pub. No.: US 2017/0251119 A1
(43) Pub. Date: Aug. 31, 2017

(54) NON-TRANSITORY COMPUTER READABLE MEDIUM, INFORMATION PROCESSING METHOD AND INFORMATION PROCESSING APPARATUS

(71) Applicant: FUJI XEROX CO., LTD., Tokyo (JP)

(72) Inventors: Issei MATSUSHITA, Yokohama-shi (JP); Masayuki IWASAWA, Yokohama-shi (JP); Yutaka IKEDA, Yokohama-shi (JP)

(73) Assignee: FUJI XEROX CO., LTD., Tokyo (JP)

(21) Appl. No.: 15/247,674

(22) Filed: Aug. 25, 2016

(30) Foreign Application Priority Data
Feb. 29, 2016 (JP) 2016-037353

(51) Int. Cl. H04N 1/00

(52) U.S. Cl. CPC H04N 1/00649; H04N 1/00204; H04N 1/00708; H04N 1/00771; H04N 1/00641; H04N 2201/0094

(57) ABSTRACT

A non-transitory computer readable medium stores a print control program causing a computer to function as a designation information acquisition unit, a paper feed information acquisition unit, and a designation information changing unit. The designation information acquisition unit acquires designation information indicating a paper feed designation of recording paper and a paper designation from print data that is generated by a printer driver based on the paper feed designation and the paper designation. The paper feed information acquisition unit acquires paper feed information indicating paper information of the recording paper and paper feed configuration of the recording paper mounted on a printing device, from the printing device before the print data is transmitted to the printing device. The designation information changing unit compares the designation information and the paper feed information and changes the designation information when a certain condition is met.

### CROSS-REFERENCE TO RELATED APPLICATIONS

This application is based on and claims priority under 35 USC 119 from Japanese Patent Application No. 2016-037353 filed Feb. 29, 2016.

### TECHNICAL FIELD

The present invention relates to a non-transitory computer readable medium, an information processing method, and an information processing apparatus.

### SUMMARY

According to an aspect of the invention, a non-transitory computer readable medium stores a print control program causing a computer to function as a designation information acquisition unit, a paper feed information acquisition unit, and a designation information changing unit. The designation information acquisition unit acquires designation information indicating a paper feed designation of recording paper and a paper designation from print data that is generated by a printer driver based on the paper feed designation and the paper designation. The paper feed information acquisition unit acquires paper feed information indicating paper information of the recording paper and paper feed configuration of the recording paper mounted on a printing device, from the printing device before the print data is transmitted to the printing device. The designation information changing unit compares the designation information and the paper feed information. The designation information changing unit changes the designation information when the paper feed designation and the paper designation of the recording paper to be printed and the paper feed configuration and the paper information of the recording paper mounted on the printing device do not coincide with each other and when print processing in the printing device can be executed by changing the paper designation of the designation information to any one of the recording paper included in the paper information of the paper feed information.

### BRIEF DESCRIPTION OF THE DRAWINGS

Exemplary embodiments of the present invention will be described in detailed based on the following figures, wherein:

FIG. 1 is a schematic diagram illustrating an example of a configuration of a printing system in an exemplary embodiment;

FIG. 2 is a block diagram illustrating an example of a configuration of a terminal device as an information processing apparatus in the exemplary embodiment;

FIG. 3 is a flowchart illustrating an example of an operation of the printing system as an action of the exemplary embodiment;

FIG. 4 is a block diagram illustrating a software configuration in a specific example of the terminal device as the information processing apparatus; and

FIG. 5 is a sequence diagram illustrating an operation of the information processing apparatus in FIG. 4.

### DETAILED DESCRIPTION

### Exemplary Embodiments

### Configuration of a Printing System

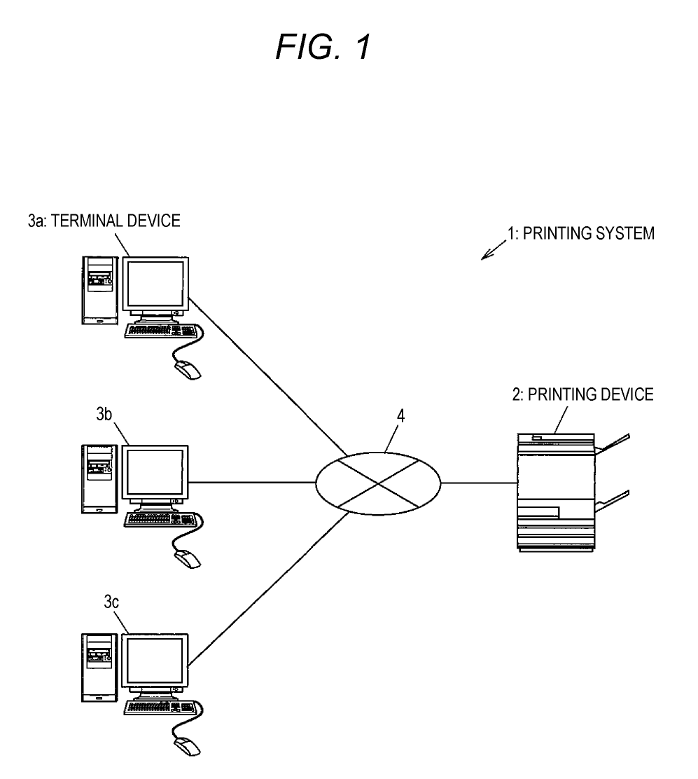

FIG. 1 is a schematic diagram illustrating an example of a configuration of a printing system in an exemplary embodiment.

As an example of the exemplary embodiment, in a printing system 1, a plural number of terminal devices 3a, 3b, and 3c are connected to a printing device (printer) 2 via a network 4. In the example in FIG. 1, three terminal devices 3a, 3b, and 3c are connected to the printing device 2. However, the number of terminal devices connected to the printing device 2 is not limited to three.

The network 4 is a communication network such as a local area network (LAN) or the Internet that performs transmission and reception of data using wired communication (electric cable, optical cable, or the like) and wireless communication (radio waves, infrared, or the like).

### Printing Device

The printing device 2 has a print function of executing printing based on information received from the terminal devices 3a, 3b, and 3c, and outputting the printed material. The printing device 2 may be a so-called multifunction machine having a scanner function or a facsimile function to optically scan the paper surface in addition to the print function. In addition, the printing device 2 includes a plural number of paper trays (paper feeding port) for sorting and outputting the printed recording paper, and a plural number of recording paper having different sizes can be mounted thereto in paper feeding directions different from each other.

### Terminal Devices

The terminal devices 3a, 3b, and 3c are information processing apparatuses that can generate information relating to print jobs designated by a user and can manage an operation of the printing device 2. Specific configurations of the terminal devices 3a, 3b, and 3c will be described below. The terminal devices 3a, 3b, and 3c include a communication unit for communicating with the network 4, an operation unit such as a touch pad for inputting operation, a display such as a liquid crystal display, a controller such as a central processing unit (CPU), and a storage unit such as a flash memory. For example, a personal computer, a personal digital assistant (PDA), or a mobile phone can be used as the terminal devices 3a, 3b, and 3c.

When referring to one device as a representative among the terminal devices 3a, 3b, and 3c, it will be simply referred to as a terminal device 3. Next, a configuration of the terminal device 3 as the information processing apparatus will be described.

### Configuration of Terminal Devices as Information Processing Apparatus

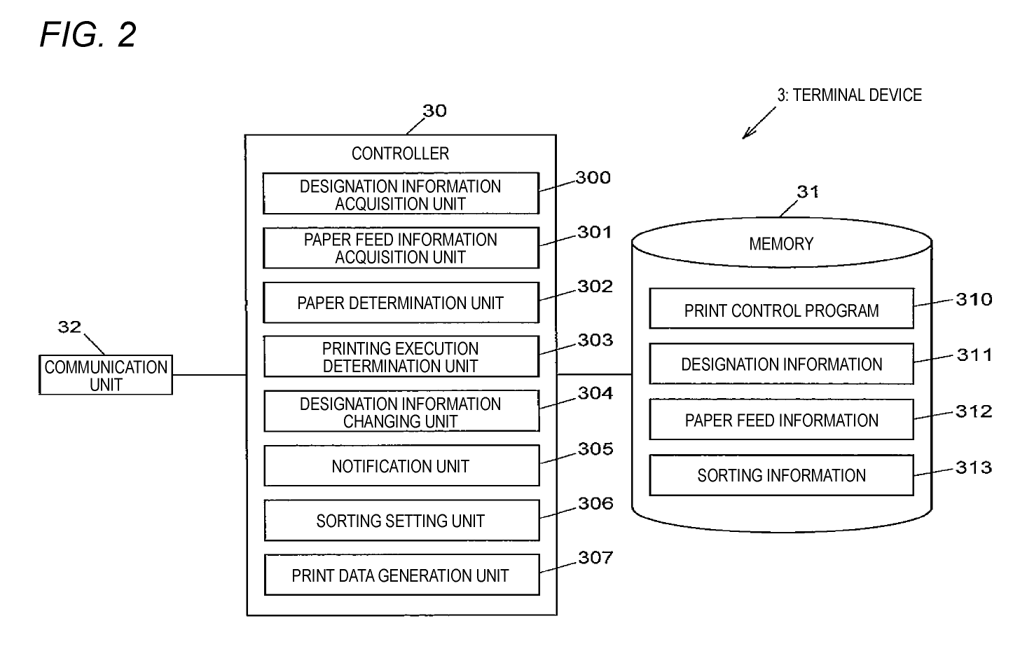

FIG. 2 is a block diagram illustrating an example of a configuration of the terminal device 3 as the information processing apparatus in the exemplary embodiment.

The terminal device (information processing apparatus) 3 includes a controller 30 that controls each unit configured with a CPU or the like and executes various programs, a memory 31 as an example of the storage device that is configured to include a recording medium such as a hard disk drive (HDD) or a flash memory for storing information, and a communication unit 32 that communicates with the outside via the network 4.

The controller 30 functions as a designation information acquisition unit 300, a paper feed information acquisition unit 301, a paper determination unit 302, a printing execution determination unit 303, a designation information changing unit 304, a notification unit 305, a sorting setting unit 306, and a print data generation unit 307 by executing a print control program 310 described below.

The designation information acquisition unit 300 acquires designation information indicating a paper feed designation and a paper designation of the recording paper to be printed, from print data generated by a printer driver as data which can be processed by the printing device 2, based on the paper feed designation and the paper designation of the recording paper for the print job designated by the user. When the user designates a size of the recording paper at the time of an instruction for printing, a paper feed configuration that can be sorted is set by the sorting setting unit 306 described below based on the above described designation. The paper feed designation in the designation information is based on the above-described setting. In addition, the paper designation of the designation information is a paper size designated by the user. The designation information acquired by the designation information acquisition unit 300 is stored in the memory 31 as the designation information 311.

The paper feed information acquisition unit 301 acquires paper feed information indicating the paper feed configuration and the paper information of the recording paper mounted on the printing device 2 from the printing device 2 before transmitting the print data generated by the printer driver to the printing device 2. The paper feed information acquired by the paper feed information acquisition unit 301 is stored in the memory 31 as the paper feed information 312.

The paper feed information acquisition unit 301 performs bi-directional communication with the printing device 2 and monitors the state of the printing device 2 in order to acquire the paper feed information, and transmits the print data generated by the printer driver as the data which can be processed by the printing device 2, to the printing device 2. The paper feed information acquisition unit 301 acquires, for example, operation information and the paper feed information of the printing device 2 by requesting the printing device 2 at predetermined time intervals. In this way, the paper feed information acquisition unit 301 can acquire the latest paper feed information of the printing device 2 immediately before the paper feed information acquisition unit 301 transmits the print data to the printing device 2, particularly, during the execution of printing.

The paper determination unit 302 compares the designation information 311 acquired by the designation information acquisition unit 300 and the paper feed information 312 acquired by the paper feed information acquisition unit 301, and determines whether or not the paper feed designation and the paper designation of the recording paper to be printed and the paper feed configuration and the paper information of the current (latest) recording paper mounted on the printing device 2 coincide with each other (whether or not the recording paper being coincident is present).

In a case where it is determined by the paper determination unit 302 that the paper feed designation and the paper designation of the recording paper to be printed and the paper feed configuration and the paper information of the recording paper mounted on the printing device 2 do not coincide with each other, the printing execution determination unit 303 determines whether it is possible to execute the print processing including the sorting in the printing device 2 or not if the paper designation of the designation information 311 is changed to any of the recording paper included in the paper information of the paper feed information 312.

Comparing the designation information 311 and the paper feed information 312, in a case where the paper feed designation and the paper designation of the recording paper to be printed and the paper feed configuration and the paper information of the recording paper mounted on the printing device 2 do not coincide with each other and when it is possible to execute the print processing including the sorting in the printing device 2 by changing the paper designation of the designation information 311 to any of the recording paper included in the paper information of the paper feed information 312, the designation information changing unit 304 changes the designation information 311. That is, in a case where it is determined by the printing execution determination unit 303 that the print processing can be executed if the paper designation of the designation information 311 is changed to any of the recording paper included in the paper information of the paper feed information 312, the designation information changing unit 304 changes the paper feed designation and the paper designation of the designation information 311.

In a case where it is determined by the printing execution determination unit 303 that the print processing cannot be executed even if the paper designation of the designation information 311 is changed to any of the recording paper included in the paper information of the paper feed information 312, the notification unit 305 notifies the user of the fact that the print processing cannot be executed, by displaying that fact on a display (not illustrated) of the terminal devices 3.

At this time, the notification unit 305 not only notifies the user of the fact that the print processing cannot be executed but also presents workarounds such as “Stop the printing”, “Print with priority on the paper feed designation in the designation information”, or “Print with priority on the paper designation of the designation information” so as to be selected by the user.

The sorting setting unit 306 sets the paper feed configuration of the recording paper in the printing device 2 used for printing each print job such that the recording paper for a plural number of print jobs in the printing device 2 can be distinguished even if the recording paper overlap with each other in one exit tray. The sorting information set by the sorting setting unit 306 is stored as sorting information 313 in the memory 31.

Specifically, the sorting setting unit 306 sets the sorting using such paper feed configuration that the paper feeding direction of the recording paper used in the current print job is different from the paper feeding direction of the recording paper output in a previous print job based on the designation information 311 acquired by the designation information acquisition unit 300 and the paper feed information 312 acquired by the paper feed information acquisition unit 301.

The print data generation unit 307 generates the print data that can be processed by the printing device 2 from the print data (original to be printed) instructed by the user as the print job. When the printing is executed, the print data generated by the print data generation unit 307 is transmitted to the printing device 2 via the paper feed information acquisition unit 301.

### Operation of the Printing System

Next, an action of the exemplary embodiment will be described along with a flowchart.

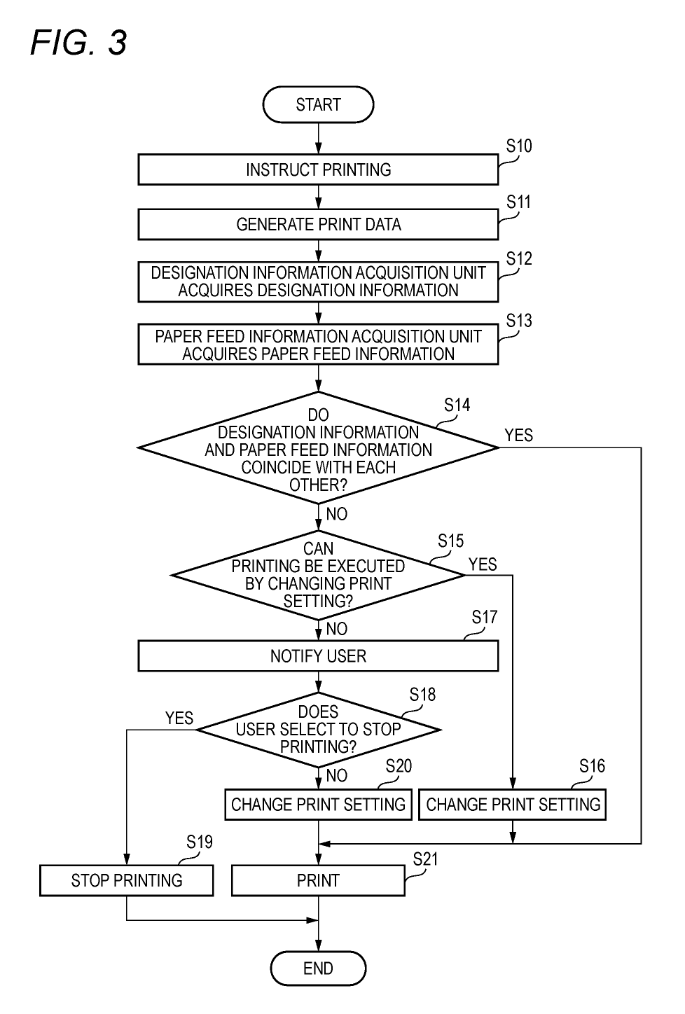

FIG. 3 is a flowchart illustrating an example of an operation of the printing system as an action of the exemplary embodiment.

When the user inputs a print job using the terminal devices 3 (S10), the print data generation unit 307 generates the print data that can be processed by the printing device 2 from the print data (original to be printed) of the print job instructed by the user (S11).

The print data generated by the print data generation unit 307 is transmitted to the printing device 2 via the paper feed information acquisition unit 301, and when transmitted to the printing device 2, the print data is temporarily held in the paper feed information acquisition unit 301.

The designation information acquisition unit 300 acquires the designation information that includes the paper feed designation and the paper designation of the recording paper to be printed, from the print data of immediately before being transmitted from the paper feed information acquisition unit 301 to the printing device 2 (S12). As described above, the designation information is configured to include the size of the recording paper designated by the user and a feeding available configuration set by the sorting setting unit 306. The designation information acquired by the designation information acquisition unit 300 is stored in the memory 31 as the designation information 311.

At the same time, the paper feed information acquisition unit 301 acquires the latest paper feed information including the paper feed configuration and the paper information of the recording paper mounted on the printing device 2 from the printing device 2 immediately before the print data being transmitted to the printing device 2 (S13). The paper feed information acquired by the paper feed information acquisition unit 301 is stored in the memory 31 as the paper feed information 312.

Next, the paper determination unit 302 compares the designation information 311 and the paper feed information 312, and determines whether the paper feed designation and the paper designation of the recording paper to be printed coincides with the paper feed configuration and the paper information of the latest recording paper mounted on the printing device 2 (S14).

When it is determined by the paper determination unit 302 that the designation information and the paper feed information coincide with each other (Yes in S14), the printing is executed according to the designation itself (S21). That is, the paper feed information acquisition unit 301 transmits the print data to the printing device 2 and causes the printing device 2 to execute the printing. In this case, since the printing is executed based on the designation information itself including the size of the recording paper and the feeding available configuration set by the sorting setting unit 306, both the printing result and the sorting result that are satisfactory to the user can be obtained.

In addition, when it is determined by the paper determination unit 302 that the designation information and the paper feed information do not coincide with each other (No in S14), the printing execution determination unit 303 determines whether or not the printing is possible if the designation information is changed (S15).

That is, there is a case where the paper feed designation and the paper designation of the recording paper to be printed and the paper feed configuration and the paper information of the current recording paper mounted on the printing device 2 do not coincide with each other because the latest paper feed information 312 of the printing device 2 due to a certain problem after the print data is generated by the print data generation unit 307 and the designation information 311 is fixed. In such a case, if the print setting is changed such that the paper designation of the designation information 311 is changed to any one of the recording paper in the paper feed information 312 with reference to the paper feed configuration of the sorting information 313 that can be sorted, it can be determined by the printing execution determination unit 303 whether the print processing including the sorting in the printing device 2 is possible or not.

When it is determined by the printing execution determination unit 303 that the print processing is possible if the print processing is changed (Yes in S15), the designation information changing unit 304 changes the setting of the paper feed designation and the paper designation of the designation information 311 such that the print processing including the sorting can be executed (S16).

The print data of which the print setting is changed is transmitted to the printing device 2 by the paper feed information acquisition unit 301, and the printing is executed according to the changed print data (S21). In this case also, both the printing result and the sorting result that are satisfactory to the user can be obtained.

When it is determined by the printing execution determination unit 303 that the print processing cannot be executed even if the print processing is changed (No in S15), that fact is displayed on the terminal devices 3 to notify the user by the notification unit 305 (S17).

At this time, the notification unit 305 presents avoidance measures such as “Please stop printing”, “Please print with the priority on the paper feed designation in the designation information”, or “Please print with the priority on the paper designation of the designation information”, and causes the user to select one avoidance measure (S18).

When the user selects to stop printing (Yes in S18), the paper feed information acquisition unit 301 does not transmit the print data to the printing device 2 and stops printing (S19).

When the user does not select to stop printing but selects to print with the priority on the paper feed designation in the designation information or on the paper designation of the designation information (No in S18), the designation information changing unit 304 changes the paper feed designation or the paper designation of the designation information 311 according to the user's selection (S20).

The paper feed information acquisition unit 301 transmits the changed print data to the printing device 2, and the printing is executed according to the changed print data (S21). At this time, since the print processing is executed according to the paper feed designation or the paper designation determined by the user even though the paper feed designation or the paper designation is different from the paper feed designation set by the sorting setting unit 306, the result does not depart from the user's intention.

### Effects of Exemplary Embodiment

According to the exemplary embodiment, when the designation information including the paper feed designation and the paper designation of the recording paper and the paper feed information including the paper feed configuration and the paper information of the recording paper do not coincide with each other, the printing is executed by rewriting the designation information. Therefore, even though the user does not instruct to print again from the application program, printing result and the sorting result expected by the user can be obtained.

In addition, when the designation information and the paper feed information do not coincide with each other, when the printing result and the sorting result expected by the user cannot be obtained even though the designation information is changed due to a limitation of the paper feed configuration of the printing device or the mounted recording paper, the user is notified of that fact. At this time also, the avoidance measures are presented again, and the user selects the avoidance measures. Therefore, the printing result and the sorting result intended by the user can be obtained.

In addition, in an ordinary situation, the satisfactory printing result cannot be obtained when the print instruction time is not clear due to an OFF state of the printing device 2 or when a large amount of print jobs are in a waiting state and thus, the paper feed information of the printing device 2 is changed during a time from the print instruction to the print starting.

However, according to the exemplary embodiment, the paper feed information acquisition unit 301 always monitors the operation state of the printing device 2, and acquires the latest paper feed information of the printing device 2, and the designation information changing unit 304 changes the designation information. Therefore, it is possible to guarantee the printing operation. In addition, since the designation information changing unit 304 rewrites the designation information of the print data, the same operation can be provided without depending on a printer controller.

### Specific Examples

Next, specific examples according to the information processing apparatus in the present invention will be described.

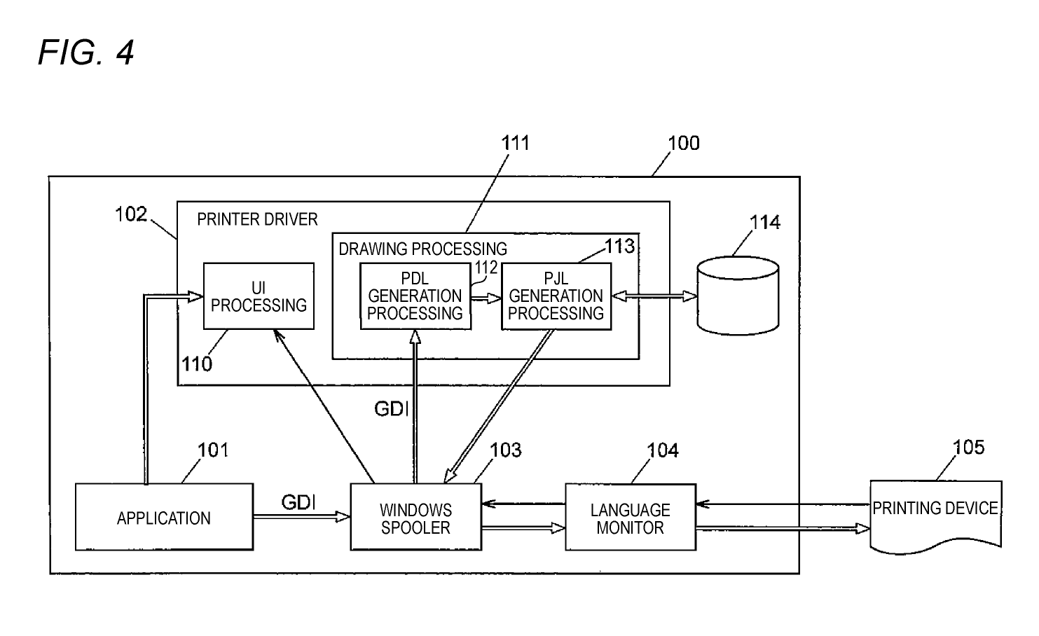

FIG. 4 is a block diagram illustrating a software configuration in the specific example of an information processing apparatus 100. That is, the information processing apparatus 100 in FIG. 4 illustrates a functional configuration example of the terminal devices 3 in the exemplary embodiment described above.

As illustrated in FIG. 4, an application program 101, a printer driver 102, a spooler (WINDOWS®spooler) 103 and a language monitor 104 are operating in the information processing apparatus 100. In addition, information processing apparatus 100 includes a memory 114 that is configured to include a non-volatile memory such as a hard disk drive (HDD) or a flash memory and functions as an example of a storage device that stores the information such as the paper feed configuration or the operation information of the printing device 105.

The application program 101 is a program that generates original data which is a base of the print data according to the user's operation and incorporates the generated original data. The printer driver 102 is a controller that transmits the original data to the printing device 105 via the spooler 103 and the language monitor 104 when receiving the print instruction from the application program 101, and controls the output of the recording paper on which the printing is executed by the printing device 105.

The printer driver 102 includes UI processing 110 and drawing processing 111 as functions thereof. The UI processing 110 functions as a user interface with the user. In addition, the drawing processing 111 includes PDL generation processing 112 and PJL generation processing 113, and generates a page description language and a printer job language from the transferred print data and the accompanying attribute information, which are print data items that can be processed by the printing device 105.

The spooler 103 is a controller that temporarily holds the print data transmitted to the printing device 105 via the graphic device interface (GDI) according to the print instruction from the printer driver 102, and reads out the print data in accordance with a predetermined regulation and transfers the print data to the language monitor 104. For example the Windows® spooler can be used as the spooler 103 as illustrated in FIG. 4.

The language monitor 104 performs bi-directional communications with the printing device 105 to monitor the state of the printing device 105, and transmits the print data that can be processed by the printing device 105 to the printing device 105. The language monitor 104 requests the printing device 105 to acquire the operation information of the printing device 105 at a predetermined time interval.

When the user gives an instruction to execute printing using the application program 101 in the information processing apparatus 100, the UI processing 110 in the printer driver 102 is called to perform the print setting, and then, printing is started. When printing is started, the print data and the accompanying attribute information are transferred to the printer driver 102 by the GDI via the spooler 103, and then, a print request is performed.

The language monitor 104 acquires the paper feed configuration of the recording paper of the printing device 105 from the printing device 105 immediately before the print request, and the paper feed configuration is transferred to the UI processing 110 from the language monitor 104. In addition, the drawing processing 111 of the printer driver 102 generates the page description language (PDL) and the printer job language (PJL) from the transferred print data and the accompanying attribute information, and transfers the PDL and the PJL to the language monitor 104 via the spooler 103.

The language monitor 104 transmits the print data that can be processed by the printing device 2 and received from the spooler 103 to the printing device 105, and the printing device 105 executes the printing according to this print data.

When receiving the print data from the spooler 103, the language monitor 104 acquires the paper feed information configured with the latest paper feed configuration and the paper information from the printing device 105, and compares the paper feed information with the designation information configured with the already-acquired paper feed designation and the paper designation of the print data. When the comparison results show that the paper feed information and the designation information do not coincide with each other, it is determined whether or not the printing result and the sorting result expected by the user can be obtained if the designation information is configured with the paper feed designation and the paper designation of the print data.

At this time, when it is determined that the result satisfactory to the user can be obtained, the language monitor 104 changes the designation information configured with the paper feed designation and the paper designation of the print data and transmits the result to the printing device 105.

In addition, when it is determined that the result satisfactory to the user cannot be obtained even if the designation information configured with the paper feed designation and the paper designation of the print data is changed, the language monitor 104 notifies the user of that fact by displaying the fact on a display (not illustrated) via the UI processing 110.

In addition, at this time, the language monitor not only notifies of the fact that the satisfactory result cannot be obtained, but also presents the avoidance measures such as to stop printing, to print with priority on the paper feed designation, or to print with priority on the paper designation to the user for selecting one avoidance measure.

As described above, the language monitor 104 has functions of the designation information acquisition unit 300, the paper feed information acquisition unit 301, the paper determination unit 302, the printing execution determination unit 303, the designation information changing unit 304, and the notification unit 305 in the exemplary embodiment described above. In addition, the UI processing 110 has a function of the sorting setting unit 306, and the drawing processing 111 has a function of the print data generation unit 307.

### Operation of the Information Processing Apparatus

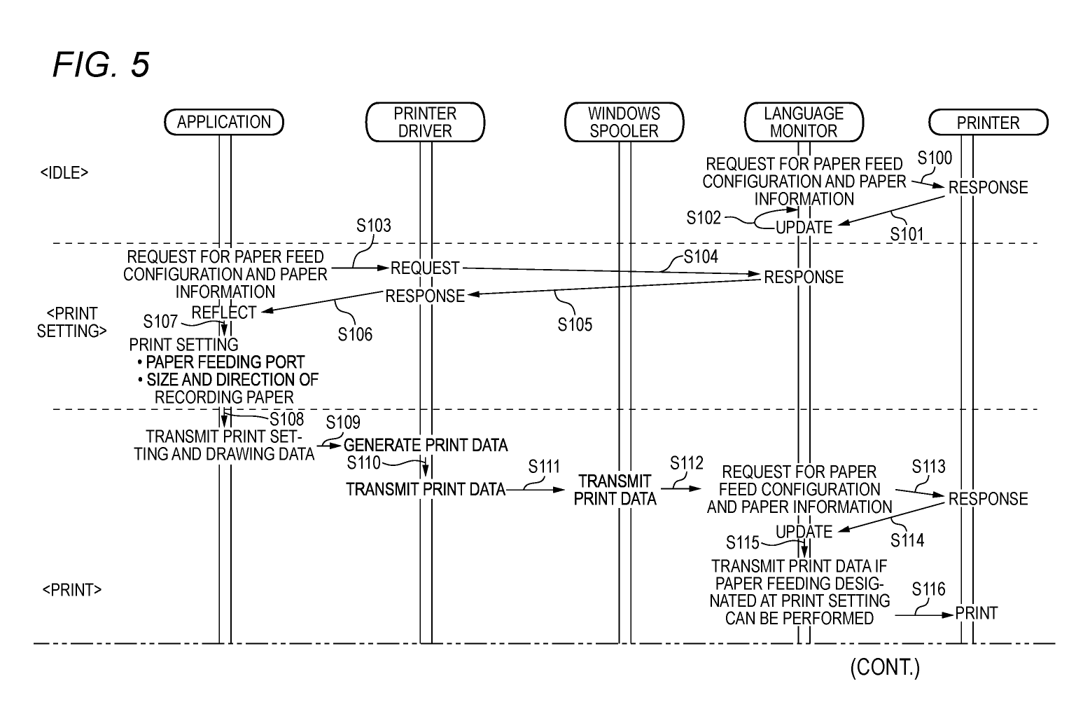

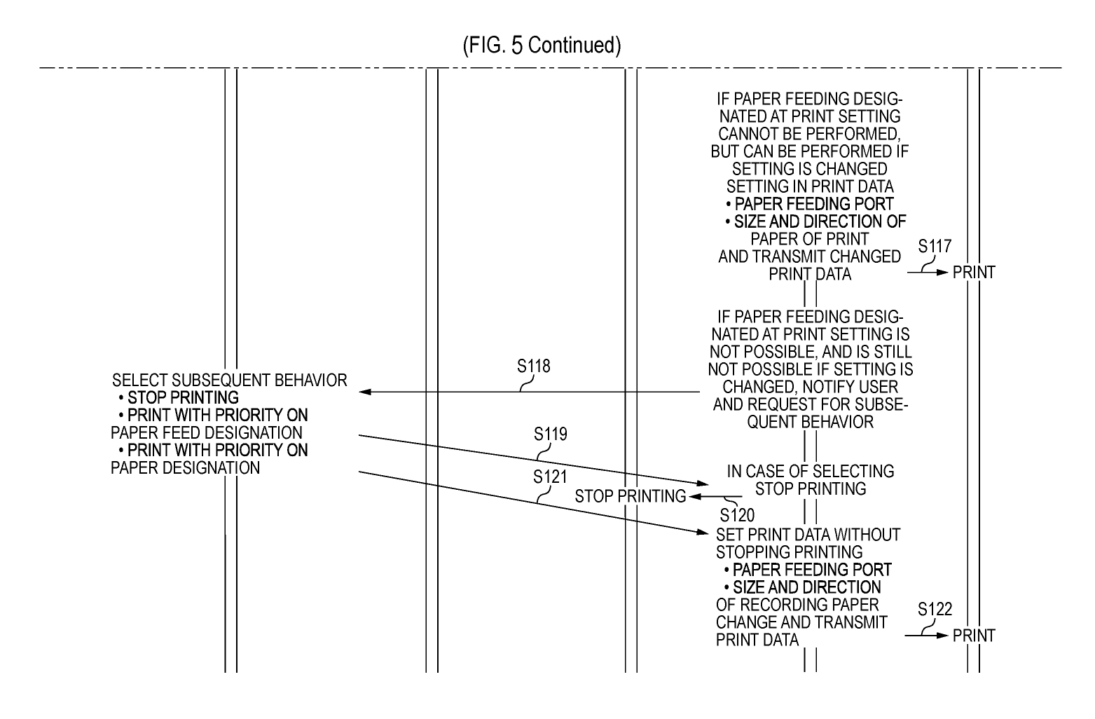

Next, an operation of the information processing apparatus 100 will be described using FIG. 5.

FIG. 5 is a sequence diagram illustrating the operation of the information processing apparatus 100 in FIG. 4.

First, in an idle state, the language monitor 104 always requests the printing device (printer) 105 for the latest paper feed configuration of the printing device 105 and the paper information at constant time intervals (S100). When a response is received from the printing device 105 (S101), the language monitor 104 updates the latest information (S102).

Next, in the print setting state, when the user requests for printing, the application program 101 requests the language monitor 104 for the paper feed configuration and the paper information via the printer driver 102 (S103 and S104). The language monitor 104 returns the response to the application program 101 via the printer driver 102 (S105, S106).

The application program 101 receiving the response designates the paper feeding port and the size and the direction of the recording paper while reflecting the response on the print data, and then, performs the print setting (S107).

Next, in the printing state, the application program 101 transmits the currently set print setting and the drawing data to be printed (S108), to the printer driver 102 (S109). The printer driver 102 receiving the print setting and the drawing data generates the print data that can be processed by the printing device 105 and transmits the result to the spooler 103 (S110, S111). The spooler 103 transmits the received print data to the language monitor 104 (S112).

When the print data is received from the spooler 103, the language monitor 104 requests the printing device 105 for the latest paper feed configuration and the paper information (S113). The language monitor 104 updates the paper feed information according to the response from the printing device 105 (S114, S115).

The language monitor 104 compares the latest paper feed information with the designation information designated during the print setting, and if it is determined that those two information items coincide with each other and is determined that the print processing is possible, such that the satisfactory printing result and the sorting result can be obtained using the paper feed configuration, then, the language monitor 104 transmits the print data to the printing device 105. When the print data is received, the printing device 105 executes the printing (S116).

In addition, the language monitor 104 compares the latest paper feed information with the designation information designated during the print setting, and if it is determined that those two information items do not coincide with each other, and if it is determined that paper feeding can be performed if the print setting is changed, then, the language monitor 104 changes the paper feeding port, the size and the direction of the paper of the print setting in the print data and transmits the result to the printing device 105. When the print data is received, the printing device 105 executes the printing (S117).

In addition, the language monitor 104 compares the latest paper feed information with the designation information designated a during the print setting, and if it is determined that those two information items do not coincide with each other, and it is determined that the paper feeding still cannot be performed even if the print setting is changed, the language monitor 104 transmits that fact to the application program 101 to notify the user of that fact (S118). In addition, at this time, the language monitor 104 presents the avoidance measures such as to stop printing, to print with priority on the paper feed designation, or to print with priority on the paper designation to the user and asks the user for the subsequent behavior (S118).

The user selects the subsequent behavior through the application program 101. That is, in a case of stopping the printing, the stopping of printing is transferred to the language monitor 104 (S119), the language monitor 104 instructs the spooler 103 to stop the printing, and the printing is stopped by stopping the transmission of the print job (S120).

In addition, when the printing with the priority on the paper feed designation or the printing with the priority on the paper designation is selected without stopping the printing, the selection is transferred to the language monitor 104 (S121), and the language monitor 104 changes the paper feeding port and the size and the direction of the recording paper according to the instruction from the user, and transmits the print data to the printing device 105 (S122). The printing device 105 receives the changed print data and executes the printing.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A non-transitory computer readable medium storing a print control program causing a computer to function as:
a designation information acquisition unit that acquires designation information indicating a paper feed designation of recording paper and a paper designation from print data that is generated by a printer driver based on the paper feed designation and the paper designation;
a paper feed information acquisition unit that acquires paper feed information indicating paper information of the recording paper and paper feed configuration of the recording paper mounted on a printing device, from the printing device before the print data is transmitted to the printing device; and
a designation information changing unit that compares the designation information and the paper feed information,
wherein the designation information changing unit changes the designation information when the paper feed designation and the paper designation of the recording paper to be printed and the paper feed configuration and the paper information of the recording paper mounted on the printing device do not coincide with each other and when print processing in the printing device can be executed by changing the paper designation of the designation information to any one of the recording paper included in the paper information of the paper feed information.

2. The non-transitory computer readable medium according to claim 1, the program causing the computer to further function as:
a notification unit that notifies of a fact that the print processing cannot be executed, when it is determined that the print processing in the printing device cannot be executed even if the paper designation of the designation information is changed to any one of the recording paper included in the paper information of the paper feed information.

3. The non-transitory computer readable medium according to claim 2, wherein when notifying of the fact that the print processing cannot be executed, the notification unit presents selectable choices including to stop printing, to print with priority on the paper feed designation of the designation information, and to print with the priority on the paper designation of the designation information.

4. An information processing method comprising:
acquiring designation information indicating a paper feed designation of recording paper and a paper designation from print data that is generated by a printer driver based on the paper feed designation and the paper designation;
acquiring paper feed information indicating paper information of the recording paper and paper feed configuration of the recording paper mounted on a printing device, from the printing device before the print data is transmitted to the printing device; and
comparing the designation information and the paper feed information, and when the paper feed designation and the paper designation of the recording paper to be printed and the paper feed configuration and the paper information of the recording paper mounted on the printing device do not coincide with each other and when print processing in the printing device can be executed by changing the paper designation of the designation information to any one of the recording paper included in the paper information of the paper feed information, changing the designation information.

5. An information processing apparatus comprising:
a designation information acquisition unit that acquires designation information indicating a paper feed designation of recording paper and a paper designation from print data that is generated by a printer driver based on the paper feed designation and the paper designation;
a paper feed information acquisition unit that acquires paper feed information indicating paper information of the recording paper and paper feed configuration of the recording paper mounted on a printing device, from the printing device before the print data is transmitted to the printing device; and
a designation information changing unit that compares the designation information and the paper feed information, wherein
the designation information changing unit changes the designation information when the paper feed designation and the paper designation of the recording paper to be printed and the paper feed configuration and the paper information of the recording paper mounted on the printing device do not coincide with each other and when print processing in the printing device can be executed by changing the paper designation of the designation information to any one of the recording paper included in the paper information of the paper feed information.
